(19) United States
(12) Patent Application Publication
(10) Pub. No.: US 2010/0223349 A1
(43) Pub. Date: Sep. 2, 2010

(54) System, method and apparatus for message targeting and filtering

(76) Inventor: Joel Thorson, Portland, OR (US)

Correspondence Address: ATER WYNNE LLP, 1331 NW Lovejoy St. Suite 900, PORTLAND, OR, 97209-2785, US

(21) Appl. No.: 12/800,078

(22) Filed: May 7, 2010

Related U.S. Application Data
(63) Continuation-in-part of application No. 10/772,202, filed on Feb. 3, 2004, now Pat. No. 7,716,291.

(51) Int. Cl. G06F 15/16; H04L 9/32; G06Q 99/00; G06Q 10/00

(52) U.S. Cl. 709/206; 726/1; 726/2; 709/203; 705/347; 705/14.66

(57) ABSTRACT

A system, method and apparatus for message targeting and filtering are provided to deliver bulk messages to demographically selected audiences of willing recipients while preserving each recipient's anonymity and control over his private personal data, accomplished by means of a radically distributed database technique in which all operations requiring unencrypted data access are distributed to individual client devices.

### RELATED APPLICATIONS

This application is a Continuation-in-Part of and claims the benefit of priority to U.S. Non-Provisional patent application Ser. No. 10/772,202 filed Feb. 3, 2004, the contents of which are hereby incorporated herein in their entirety by this reference.

### FIELD OF THE INVENTION

The present invention relates to the field of distributed databases. In particular, the present invention relates to a message targeting and filtering database system.

### BACKGROUND OF THE INVENTION

Internet marketing entails a central dilemma. Advertisers and fund-raisers require cost-effective bulk methods of disseminating messages. The effectiveness of bulk messaging is enhanced by the use of personal profiling information to narrow the scope of distribution to individuals deemed most likely to be receptive. Databases of such information are commonly rented and sold for use by third parties, and have accordingly become valuable financial assets. For individual subjects, these practices create issues of privacy, ownership and control over their personal information. Such concerns have been exacerbated by the explosive growth of networking technology, which accelerates the propagation of personal information via the Internet.

Bulk messaging explicitly requested by an individual subject is known as permission-based or “opt-in” messaging. Examples include “listserv” email lists allowing subjects to request notification regarding topics or events of interest, and World Wide Web (Web) sites which invite visitors to fill out forms identifying subject or product categories about which they would like to receive information. In other cases, the opt-in election may be less obvious, as when an opt-in check box is pre-checked by default, or when permission to send messages is embedded in a lengthy end-user license to which a subject must agree before using a product or service.

Unsolicited messaging methods include both legitimate (“opt-out”) and ‘illegitimate’ techniques, the latter commonly known as “spam.” Unsolicited bulk messaging, while cost-effective, may have the effect of antagonizing its recipients, many of whom view it as “junk mail,” don't read it, and may object to receiving it. Those who do read a particular message may bring to it a skeptical or even hostile attitude toward the product or service offered, the sender, or the messenger.

The opt-out model places the burden of diligence on the individual subject, who is deemed to have implicitly “opted in” merely by buying something on-line, opening an account, registering a warranty, filling out a preference survey, making a charitable donation, or posting a message to a news or discussion group. The organization collecting the information is presumed entitled not only to contact the subject at will, but to share her personal information with other organizations for profit, without explicit permission. The subject typically discovers after the fact that she has unknowingly opted in to a stream of unwanted messages from a variety of sources, and moreover has no way of tracing a given message back to a particular opt-in decision, and has no way of knowing who made money from the sharing of her personal information.

Typically, opt-out bulk messaging affords the subject a periodic opportunity to remove herself from a messaging database; however, opting out is often made difficult or inconvenient. Many consumers resent the burden of effort the current opt-out system imposes on them, and most do not persist in opting out at every opportunity, given the great number of organizations and companies that typically have access to their personal information. Moreover, “spammers” are known to use opt-out responses as corroboration that the contact information is indeed current, and they can be expected to exploit official “no-spam” lists the same way, given the opportunity.

Corporate privacy policies governing the use of opt-out contact information do not have the legal force of contracts, and can be changed by the marketing organization at will. Mergers, acquisitions, and financial exigency have led corporations to repudiate the privacy assurances under which consumers volunteered information. Bankruptcy proceedings result in the sale of customer databases and other contact lists to organizations which do not consider themselves accountable for the bankrupt company's privacy assurances and which are not held accountable under current law.

The decentralized and international nature of the Internet has spawned a huge and growing market in illicit personal information without the protection of privacy rules, opt-in, opt-out or otherwise. It is a relatively easy matter for organizations, particularly unregulated offshore companies, to use the so-called “dark Internet,” including inadequately protected private computers, to bombard consumers with messages using contact information obtained surreptitiously, without fear of accountability.

Preventive approaches to spam control have proven ineffective, owing to email's permissive design philosophy (diffuse ownership, distributed governance, voluntary compliance, etc.) and its inviting incentive structure (low entry cost, economies of scale, low risk of detection and punishment for bad behavior, etc.). Anti-spam innovation has therefore focused on prophylaxis, mainly consisting of content filtering. This approach suffers from an inherent precision problem: no matter how tight or loose the filtration screen, there remains a risk either of letting illicit messages through or blocking legitimate ones. Another unintended consequence is a dramatic increase in the intensity of the assault, as spammers, reacting to the ever-increasing effectiveness of filtering technology, unleash an ever-increasing volume of messages into the channel. Perhaps worst of all, from the standpoint of privacy, is the invasiveness of the filtration approach, which requires automated scanning and statistical analysis of message content. Whether or not the results are ever seen by humans, whether or not they are used for marketing purposes or shared with third-parties, automated scanning reinforces a growing trend of tolerance toward intrusive examination of private communications.

An alternative approach, employed by some existing and proposed spam control systems, is based on rigorous identity authentication of senders combined with the use of a sender reputation database containing each registered sender's cumulative reputation for honest and compliant practice among email recipients. If widely adopted, this approach might serve as a spam deterrent, in that an unscrupulous bulk message sender, having once gotten a spam message through, would elicit negative feedback from recipients, thereby ruining the sender's reputation rating, making further success unlikely. The practice known as “account churning”, which involves the avoidance of accountability by opening many accounts to send a single spam message from each, could also be rendered cost-ineffective by proper allocation of bulk messaging costs between per-account and per-message charges.

However, reputation-filtering systems envisioned to date fall short in regard to individual privacy and choice. All apply reputation filtering in a centralized fashion (i.e., on system servers). Some recipients, given the opportunity, might wish to lower their reputation filtering threshold for some kinds of spam in exchange for remuneration, while completely blocking other kinds. Further, no system envisioned to date provides any relief from intrusive content scanning, on which conventional spam filtering is based. Nowhere is there any consideration given to delegating the reputation screening function entirely to the individual user, thereby eliminating the need for content filtering altogether.

What is needed is a means of (a) providing messaging access to a highly targeted audience of willing message recipients, while (b) securing each individual's privacy, selectivity, ownership, and financial participation in the use of his personal information, (c) deterring spam by rendering it cost-ineffective, (d) eliminating the need for automated scanning of message content as required by conventional spam filtering techniques, and (e) ensuring legal accountability when data access is mandated by a court of law. Such a system would serve not only individual interests but marketing interests as well, by reclaiming the message channel, enhancing the cost-effectiveness of targeted bulk messaging, and regaining the attention, participation and goodwill of customers, clients, consumers and contributors.

### SUMMARY OF THE INVENTION

The invention is a message targeting and filtering system and method based on an extreme application of distributed database technology in which the central database service defines a uniform data format or “schema,” but is otherwise relegated to a subordinate role in which it performs only storage and clearinghouse functions that do not require unencrypted data access. All database functions requiring unencrypted data access, including modification, querying and/or schema migration of data records, are delegated to client-side software agents deployed on devices under the personal control of individual database subjects. The invention contemplates various methods of data security and various methods of anonymous payments for message consumption.

### BRIEF DESCRIPTION OF THE DRAWINGS

The invention is illustrated by way of example in the figures of the accompanying drawings in which like reference numerals refer to similar elements. and in which:

FIG. 1 is a block diagram of a client-server architecture within which the teachings of the invention can be practiced, in accordance with one embodiment of the invention;

FIG. 1A is a block diagram of the components of a personal record in accordance with one embodiment of the invention;

FIG. 1B is a block diagram of the components of a message deposit-in accordance with one embodiment of the invention;

FIG. 2 is a block diagram illustrating acquisition of a client session update during session startup in accordance with one embodiment of the invention;

FIG. 3 is a block diagram illustrating the processing of a message permission query in accordance with one embodiment of the invention; and

FIG. 4 is a block diagram illustrating message delivery and confirmation in accordance with one embodiment of the invention.

FIG. 5 is a block diagram illustrating a sender reputation feedback system and method that features spam-deterrence, rather than prophylaxis, in accordance with one embodiment of the invention.

### DETAILED DESCRIPTION OF THE PREFERRED EMBODIMENTS

In the following description, various aspects of the invention, A Method and Apparatus for a Message Targeting and Filtering Database System (MTFDBS), are described. In one embodiment MTFDBS is a radically distributed database system that provides for the delivery of bulk messages to demographically selected audiences while preserving each individual subject's anonymity and control over her own personal records. Specific details are set forth in order to provide a thorough description. However, it is understood that embodiments of the invention may be practiced with only some or all of these aspects, and with or without some or all of the specific details. In some instances, well-known features have been omitted or simplified in order not to obscure the understanding of this description. It is further understood that the various aspects of the method may or may not be carried out in the order they are presented. Also, repeated usage of the phrase “in one embodiment” does not necessarily refer to the same embodiment, although it may.

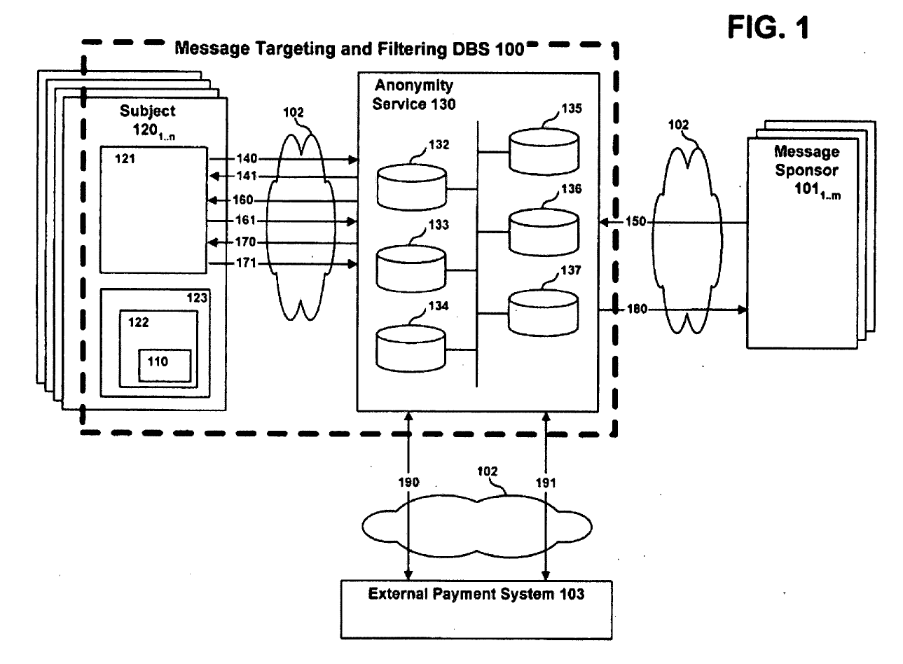

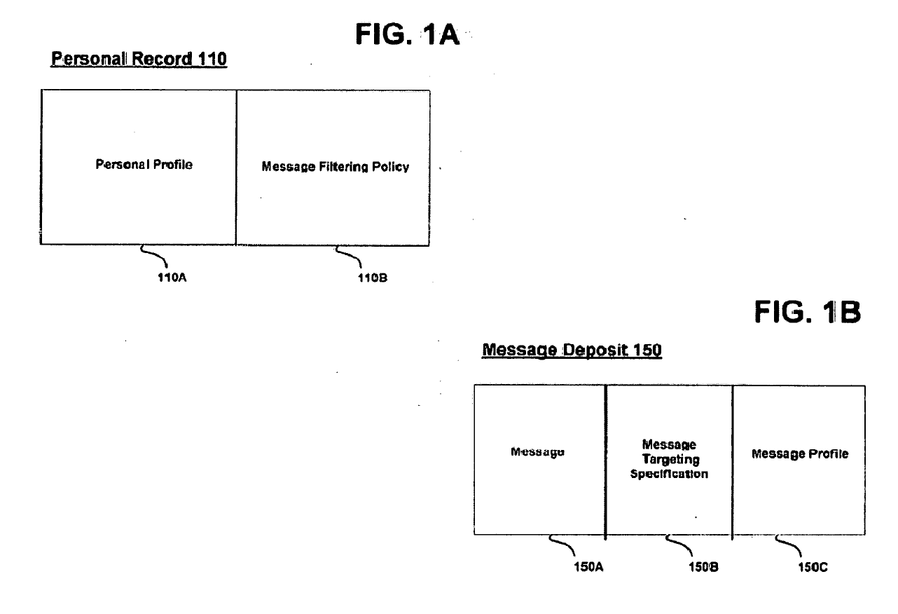

FIG. 1 is a block diagram of a client-server architecture within which the teachings of the invention can be practiced. In one embodiment MTFDBS 100 is a distributed client-server database system consisting of Anonymity Service 130, a self-contained database service with distinct database responsibilities and client interactions and with two categories of clients: message sources and message recipients/self-profiling subjects. The message source clients are shown in FIG. 1 as Message Sponsor 101_{1 . . . m} to indicate that there may be one or many message sources. In the description below, Message Sponsor 101 refers to a message source for ease in description but does not limit the number or type of message sources. The message recipients/self-profiling subjects are shown in FIG. 1 as Subject 120_{1 . . . n} to indicate that there may be one or many message recipients/self-profiling subjects. In the description below, Subject 120 interchangeably refers to an individual subject (e.g., user) and/or a private messaging device under the control of an individual subject for ease in description, but does not limit the number or type of message recipients/self-profiling subjects. MTFDBS 100 may have any number of message source clients and any number of message recipient/self-profiling subject clients. Any number of message sources may communicate through MTFDBS 100 to one or many subjects.

Anonymity Service 130 is the intermediary that delivers targeted messages from Message Sponsor 101 to all Subject 120_{1 . . . n} willing to receive them, returning confirmations enabling Message Sponsor 101 to be billed for message deliveries and Subject 120 to be reimbursed for message consumption, all the while preserving each Subject's 120 anonymity and data privacy. MTFDBS 100 achieves this by a radical and novel decentralization of the classic client-server database model.

The two categories of clients communicate directly with Anonymity Service 130 but not with each other except indirectly through Anonymity Service's 130 intermediation. Anonymity Service 130 communicates with Subject 120_{1 . . . n} and Message Sponsor 101_{1 . . . m} via Network 102. Network 102 may be a private local-area network, a wide-area network, the Internet, or any other digital network, the transport mechanism for which may be Ethernet cable, optical fiber, infrared, wireless, or any other physical transport mechanism. Such communication means are well known in the art and will not be further discussed herein except to note that the invention is not constrained to any particular type or mechanical means of communication.

Referring to FIG. 1, Message Sponsor 101 sends Message Deposit 150 to Anonymity Service 130. In one embodiment, Message Deposit 150 contains Message 150A accompanied by Message Targeting Specification 150B and Message Profile 150C characterizing Message 150A and its sender. Message Targeting Specification 150B is for use in directing Message 150A to an audience of particular interest, and may identify a specific recipient or recipients, or may describe a class of recipients in general demographic terms. Message Profile 150C contains information useful to recipients in deciding whether to accept Message 150A, including, for example, the type of message content, the reputation of the sender based on prior message feedback, a reimbursement offer for message acceptance, etc. Message Targeting Specification 150B and Message Profile 150C together comprise a database query expressed in terms of a uniform data format or “schema” specified by Anonymity Service 130.

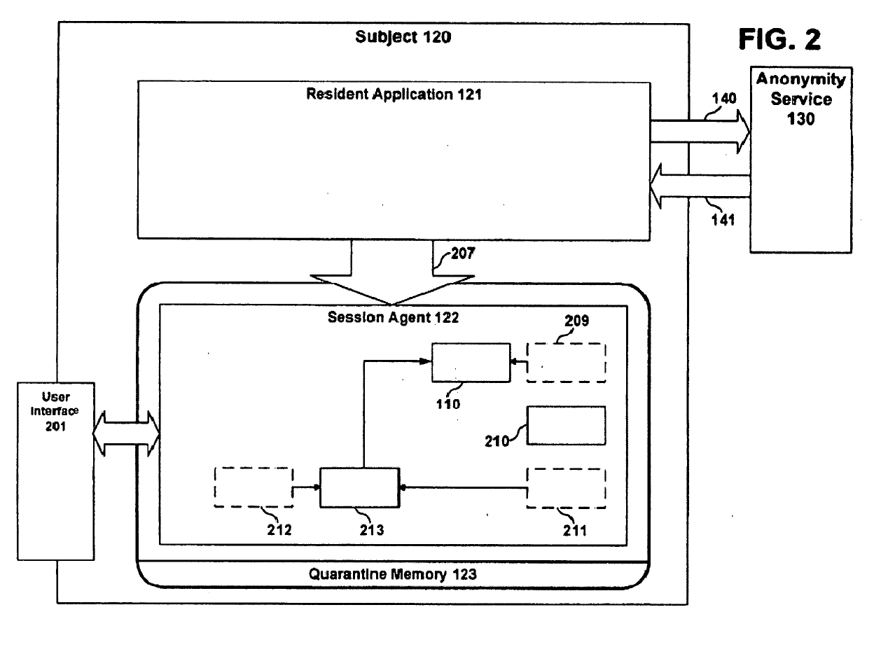

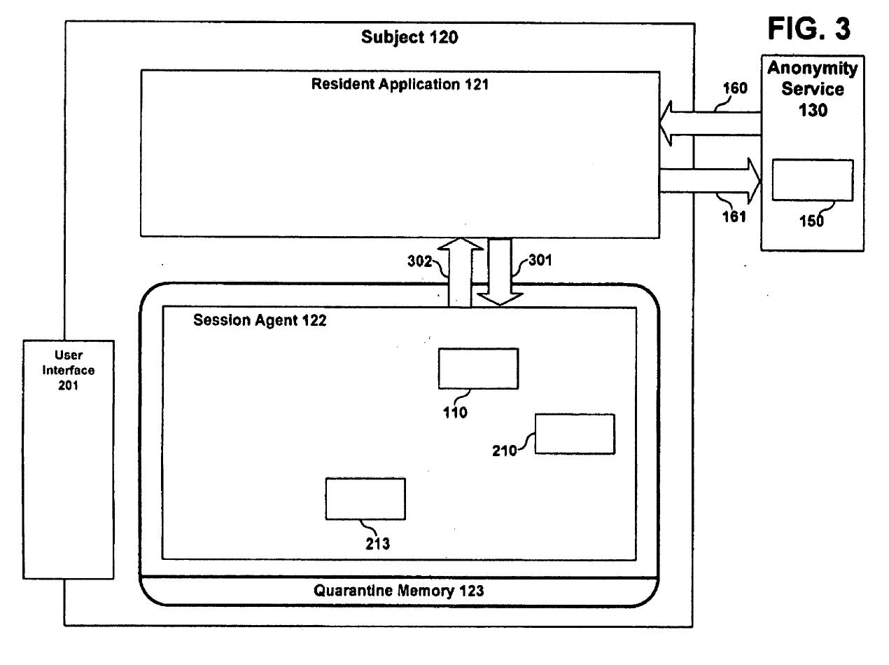

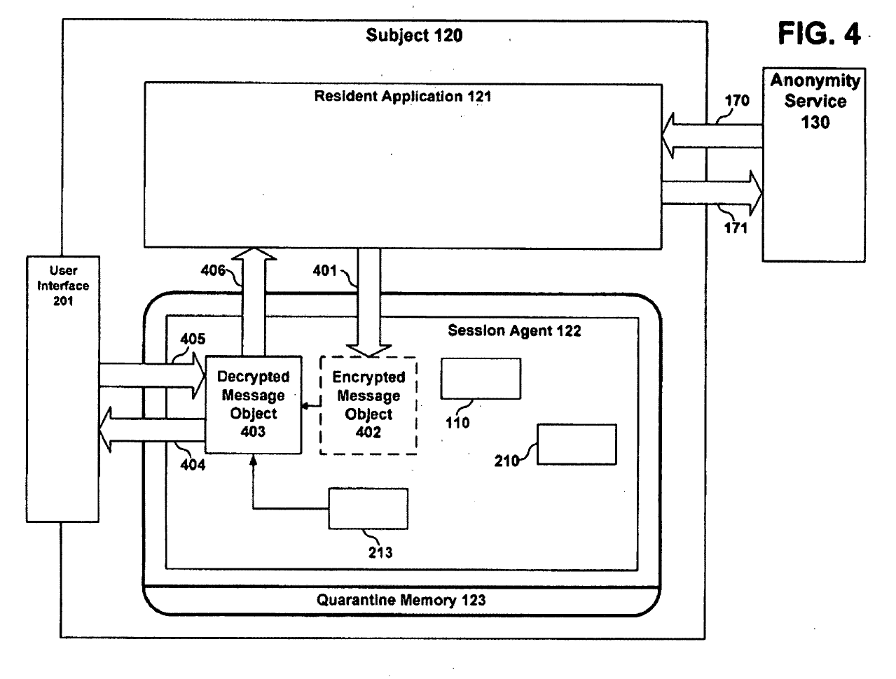

Anonymity Service 130 stores Message Deposit 150 in Message Store Database 136 until delivery to all willing recipients Subject 120_{1 . . . n} is complete. Independently, as further described below in reference to FIG. 2, Subject 120 initiates a client session by sending Session Agent Download Request 140. Anonymity Service 130 responds with Session Agent Download 141, which equips Subject 120 with Personal Record 110 belonging specifically to Subject 120, and everything needed to perform database queries on Personal Record 110. Anonymity Service 130 sends Message Permission Query 160 to Subject 120. Subject 120 determines whether or not to accept the message by comparing information in Personal Record 110 against information contained in Message Permission Query 160, as described below in reference to FIG. 3. Based on the outcome of this query, Subject 120 sends Message Permission Query Result 161 to Anonymity Service 130. If Message Permission Query Result 161 is positive, Anonymity Service 130 sends Message Delivery 170 to Subject 120, as described below with reference to FIG. 4. When Anonymity Service 130 receives Delivery Acknowledgement 171 from Subject 120, Anonymity Service 130 sends Delivery Notification 180 to Message Sponsor 101.

FIG. 1A is a block diagram of the components of a personal record in accordance with one embodiment of the invention. Personal Record 110 consists of a self-describing personal profile (Profiling Information 110A) and a set of message filtering policies (Message Filtering Policies 110B). Referring now to FIG. 1 and FIG. 1A, Personal Record’ 110 is created and maintained by Subject 120 in the private confines of her own personal device. Subject's 120 device may be any of a wide range of devices, such as a desktop or portable computer, a “smart” cell phone, a personal digital assistant, a television set-top box, game console, etc. Typically, Profiling Information 110A is data that Subject 120 may wish to keep private but is also data that is useful to Message Sponsor 101 for targeting messages to a receptive audience, for example, age, sex, income, zip code, Social Security number, religious and political affiliations, ethnic origin, health information, credit card numbers, insurance and other preferences, hobbies and interests, Internet usage, etc. Message Filtering Policies 110B enable Subject 120 to restrict message delivery. For example, Subject 120 may filter messages by sender and sender category (direct business relationship, marketing affiliate, unaffiliated third party, etc.), message category (personal, advertising, promotional, political, charitable fund-raising, etc.), content (recreation, investments, consumer products, etc.), sponsor reputation ratings or other types of aggregate feedback, and the like. Message Filtering Policies 110B may also detail minimum reimbursement for allowing access to data or receiving messages.

Personal Record 110 is created and maintained at the client node, Subject 120, and encrypted before transmittal to the central database facility, Anonymity Service 130, via a secure channel. Specific encryption techniques, digital signing and authentication methods, transport protocols, message exchange protocols (communication sequences), internal data representation, and other such adaptation details are peripheral to the invention and are not described herein.

FIG. 1 depicts the system-level interactions between MTFDBS 100 clients and servers. It intentionally simplifies and omits important aspects of Subject's 120 internal organization and operation, which are depicted in greater detail in FIGS. 2-4. Referring to. FIG. 1, all operations requiring unencrypted access to Personal Record 110 are delegated to Resident Application 121 residing on the Subject's 120 client device. Resident Application 121 may be any of a variety of software applications, or alternatively an extension, plug-in, add-in or other component of any such application, adapted for carrying out the system's distributed operations in a particular client-side software and hardware environment. For example, Resident Application 121 may be a secure private email application running on a desktop computer, a voicemail program running on a “smart” cell phone, a computer game running on a game device connected to a television set, a plug-in extension to an Internet browser running on a wireless personal digital assistant, etc. Resident Application 121 typically will not itself perform unencrypted database operations; for this it typically downloads various code and data elements including an updated copy of Session Agent 122 to which Resident Application 121 delegates all such operations. Session Agent 122 and its role are described in greater detail in reference to FIGS. 2-4 below. In one embodiment, Resident Application 121 is not itself capable of performing unencrypted database operations, and it must download the various code and data elements.

Operations requiring unencrypted access to the contents of Personal Record 110 are performed by Resident Application 121 only within a secure, isolated region of process memory, referred to herein as Quarantine Memory 123, within an individual Subject's 120 client device, such that unencrypted data cannot be copied outside Subject's 120 direct and immediate control. Thus the only place that Personal Record 110 exists in unencrypted form is on the device of the corresponding Subject 120 and then only in Quarantine Memory 123, not touching storage media or traveling across a wire, for example, where it could be accessed by someone without permission.

Anonymity Service 130 maintains Personal Records Database 133 for storage of Subject's 120 personal data. Personal Records Database 133 is a database system in the widely accepted sense of the term: that is, it provides storage for multiple data records in a common format or “schema,” and methods for the creation, modification, deletion, and querying of such records, as well as their conversion (“migration”) to a new format if and when the schema changes. Unlike other databases, however, Personal Records Database 133 is fully distributed in design and operation, depending on client-side software agents for all operations requiring unencrypted access to data, such as data record modification, query, and schema migration. In respect to Records Database 133, Anonymity Service 130 is relegated to a subordinate role involving only data-blind functions, such as storage of encrypted data records, schema maintenance, updating of client-side software agents, and distribution of data operations to client nodes.

Referring again to FIG. 1, Anonymity Service 130 may maintain multiple databases in addition to Personal Records Database 133, such as Subject Login Account Database 132, for storing account information; Subject Accounts Payable Database 134, for storing reimbursement credit information; Sponsor Accounts Database 135, for storing sponsor profile and reputation information; Message Store Database 136, for storing Message 150 waiting to be delivered; and Sponsor Accounts Receivable Database 137, for storing delivery debit information. As will be recognized by those in the art, these databases are listed for descriptive purposes and may or may not have this actual configuration; i.e., the databases may be merged or divided in different ways and may or may not all exist.

In one embodiment, one of the roles of Anonymity Service 130 involves overseeing Payments 190 and Collections 191 managed by an External Payment System 103. External Payment System 103 is the mechanism used for collecting payments from Message Sponsor 101 and distributing reimbursements associated with acceptance and delivery of some messages to Subject 120. External Payment System 103 may be a conventional banking network, an on-line payment system, a customer reward or loyalty system, or any other mechanism or combination of mechanisms for transacting debits and credits over a network. The privacy and anonymity of Subject 120 are maintained throughout any payment transactions by the use of anonymous identifiers, or the like.

FIG. 2 is a block diagram illustrating acquisition of a client session update in accordance with one embodiment of the invention. Referring to FIG. 2, Subject 120 initiates a message session via User Interface 201. User Interface 201 may be any of the variety of devices designed for interactive input; i.e., keyboard, mouse, game controller, remote control device, telephone touchtone keys, etc., used in conjunction with some manner of output device; i.e., computer display, television screen, speaker, headphones, etc. The configuration of User Interface 201 depends on Subject's 120 personal device and the functions of Resident Application 121 as described above, but is not limited by the present invention.

In one embodiment, to initiate a message session, Subject 120 may log into the MTFDBS 100 system by interacting with Resident Application 121 via User Interface 201. For example, if Resident Application 121 is an email program, Subject 120 may initiate the login sequence by checking her email. Resident Application 121 contains adapter software which customizes the login sequence as required by the particular capabilities and constraints of Subject's 120 device and its operating system. The login process includes the downloading from Anonymity Service 130 of all code and data elements needed for performing operations on Personal Record 110. Resident Application 121 responds to Subject's 120 login request by sending Session Agent Download Request 140 to Anonymity Service 130.

Anonymity Service 130 authenticates Session Agent Download Request 140 by any of the various methods known to those in the art as mentioned above, and responds by sending Session Agent Download 141. Session Agent Download 141 contains an updated copy of the MTFDBS 100 message session software (Session Agent 122), an encrypted copy of Subject's 120 personal data record (Encrypted PR 209), an encrypted copy of Subject's 120 private encryption key (Encrypted Private Key 211), and a public key (Public Key 210) for encrypting return communications.

Referring still to FIG. 2, in one embodiment Resident Application 121 installs Session Installation 207, which includes Session Agent 122, Encrypted PR 209 and Public Key 210 and Encrypted Private Key 211, in Quarantine Memory 123. Upon Resident Application's 121 request, Session Agent 122 obtains Personal Passphrase 212 from Subject 120, and uses Personal Passphrase 212 to decrypt Encrypted Private Key 211. Session Agent 122 then uses the resulting unencrypted Private Key 213 to decrypt Encrypted PR 209, yielding Personal Record 110 in unencrypted form. At this point Session Agent 122 has full unencrypted access to Personal Record 110 and is ready to handle all data-sensitive responsibilities, such as filtering, receiving and responding to messages from Message Sponsor 101. Public Key 210, Encrypted Private Key 211, and Personal Passphrase 212 may be components of various encryption techniques. Their use in this description is to indicate the level of security necessary to protect the privacy of the data and anonymity of Subject 120. As is understood by those in the art, various encryption techniques may use all, some or none of these components, and the present invention is not limited to a specific encryption technique. In alternative embodiments, a passphrase equivalent may be provided by a “smart card,” or a biometric identification method such as thumbprint or retinal scan identification, etc. A central characteristic of all embodiments, however, is the inability of Anonymity Service 130 to access Subject's 120 unencrypted personal data, the decryption of which requires an element kept by Subject 120 under his separate personal control and provided on request, and which cannot be duplicated or transmitted beyond the confines of Quarantine Memory 123.

FIG. 3 is a block diagram illustrating the processing of a message permission query in accordance with one embodiment of the invention. Session Agent 122 performs the database functions distributed to the client device including data modification. schema migration, and queries. Continuing with the email example. Anonymity Service 130 may have an email message (Message 150A) from Message Sponsor 101 waiting to be delivered. Anonymity Service 130 sends Message Permission Query 160 to Resident Application 121 notifying Subject 120 that Message 150A is available. Resident Application 121 relays the query to Session Agent 122 as Permission Query 301. Session Agent 122 carries out the requested message permission query in an attempt to obtain a reciprocal match between message and recipient. Permission Query 301 compares Message Targeting Specification 150B with Personal Profile 110A to determine if Subject 120 is an intended recipient, and compares Message Profile 150C with Message Filtering Policies 110B to determine if Subject 120 is willing to accept the message. Given a positive match, Session Agent 122 may additionally interact with Subject 120 via User Interface 201 to confirm her willingness to accept Message 150A.

Session Agent 122 returns the results of the database query to Resident Application 121 in Permission Query Result 302. Resident Application 121 relays the information in Permission Query Result 302 to Anonymity Service 130 as Message Permission Query Result 161.

The message permission query illustrated in FIG. 3 is one of many database operations delegated to client nodes. Other such distributed operations may include data modification, schema migration, other types of queries, etc. Session Agent 122 may perform a generic database query that does not result in message delivery, such as a polling query or request for demographic information which requires access to Personal Record 110 but does not require the delivery of a message. Other capabilities of Session Agent 122 include schema migration of the data in Personal Record 110 in response to a change in data format requested by Anonymity Service 130, and allowing Subject 120 to modify the data in Personal Record 110 using User Interface 201.

Refer now to FIG. 4, which is a block diagram illustrating message delivery and confirmation in accordance with one embodiment of the invention. Having received permission to deliver the message, Anonymity Service 130 sends Message Delivery 170 to Resident Application 121. Each of the transmissions between Anonymity Service 130 and Resident Application 121 are sent with various levels of encryption to protect the privacy of the data and the anonymity of Subject 120. Thus Message Delivery 170 consists of Message Object Installation 401, which installs Encrypted Message Object 402 in Quarantine Memory 123 for processing by Session Agent 122.

In one embodiment, Session Agent 122 uses Private Key 213 to convert Encrypted Message Object 402 into Message Object 403. Message Object 403 may be an email message, a bitmap image intended for display within an interactive game session, a cellular telephone message, an Internet survey, etc. Session Agent 122 communicates with Subject 120 via User Interface 201, sending Message Output 404 and receiving Interactive Input 405. The communication is determined by the character of Resident Application 121, i.e., email, voicemail, game, etc., and by Message Object 403, and by Interactive Input 405 from Subject 120. After Session Agent 122 delivers the message, Subject 120 determines whether or not to “consume” the message, i.e., an email message delivered to a mailbox can still be deleted without being read. Message Object 403 may require interaction with Subject 120 to verify that the message has been consumed. Session Agent 122 compiles message delivery information, verification of message consumption if required, and reputation feedback on Message Sponsor 101 from Subject 120, creating Delivery Confirmation 406. Session Agent 122 transmits Delivery Confirmation 406 to Resident Application 121. Resident Application 121 relays the information to Anonymity Service 130 as Delivery Acknowledgement 171. When Subject 120 ends the client session, everything in Quarantine Memory 123 is deleted.

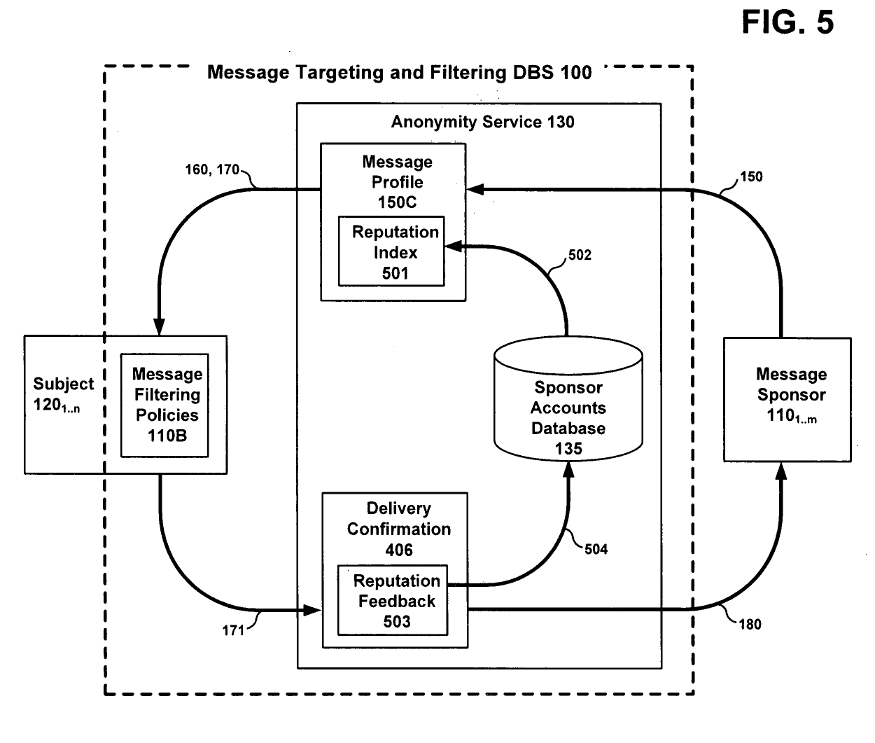

FIG. 5 is a block diagram depicting those elements of the invention that comprise a sender reputation feedback system and method in accordance with one embodiment. The communication system depicted in this example is an email system, although the same teaching may be applied analogously in other forms of Internet communication. Every Message Sponsor 110_{1 . . . m} must have established an account in Sponsor Accounts Database 135 as a prerequisite to sending bulk messages. This account contains customary authentication assets affording a reliable way of uniquely identifying the Message Sponsor 110_{1 . . . m}. It also contains Reputation Index 501, a numerical score reflecting Message Sponsor's 110_{1 . . . m} cumulative reputation for honest practice, based on feedback previously provided by Subjects 120_{1 . . . n} in response to Message Sponsor's 110_{1 . . . m} past messages. Reputation Index 501 may also include information about the feedback sample size on which the score is based, providing a measure of statistical confidence.

Referring to FIGS. 1B and 5, Message Sponsor 110_{1 . . . m}, in submitting Message Deposit 150, must provide, in addition to Message 150A, Message Profile 150C characterizing the message in accordance with the filtering database schema published by MTFDBS 100. To these message components provided by Message Sponsor 110_{1 . . . m}, MTFDBS adds the sender's Reputation Index 501, which it obtains from Sponsor Account Database 135 by means of Reputation Index Query 502. Portions of an exemplary but non-exclusive embodiment of a server-side Reputation Index-related component of the Message Targeting and Filtering Database System (e.g., describing structure for performing spam-control-related operations carried out by Anonymity Service 130) are represented by the following pseudocode:

| | |
|---|---|
| while (true) | // endless loop -- Anonymity Service 130 is always running |

{

if (Anonymity Service 130's event queue is empty)
{

| | |
|---|---|
| sleep | // wait for event notification |
| continue | // next ‘while’ loop iteration |

}
while (Anonymity Service 130's event queue contains events to process)
{

event = next event from head of queue
If (event is a Message Deposit 150 from a Message Sponsor 101)
{

messageDeposit = event
store messageDeposit in Message Store Database 136
// Now perform a distributed message-delivery permission database query
// on the entire Subject 120_{1..n} membership, to establish list of recipients who
// are both (1) targeted by sponsor's Message Targeting Specification 150B
// and (2) willing to accept message as described in sponsor's Message
// Profile 150C (including sponsor's Reputation Index 501)
retrieve sponsor's Reputation Index 501

// obtained from Sponsor Accounts Database 135 by means of
// Reputation Index Query 502 (note: Reputation Index 501 contains
// not only a numerical score but the feedback sample size on which
// the score is based)

insert Reputation Index 501 into Message Permission Query 160
foreach (individualSubject in Subject 120_{1..n})
{

if (individualSubject is currently logged in)

transmit Message Permission Query 160 to individualSubject

else
{

// store permission query in a deferred-query list, causing it to
// be performed upon individualSubject's next login (up to some
// time limit agreed upon with sponsor in advance)

}

}

}
else if (event is a Message Permission Query Result 161 from an individual Subject 120)
{

queryResult = event as Message Permission Query Result 161
individualSubject = Subject 120 sender of queryResult
deliveryIsMutuallyPermissible = boolean result of query, from queryResult
if(deliveryIsMutuallyPermissible)
{

messageId = database identifier of originating Message Deposit 150 from queryResult
messageDeposit = originating Message Deposit 150 from Message Store Database 136

// indexed by messageId

message = Message 150A from messageDeposit
targetingSpec = Message Targeting Specification 150B from messageDeposit
messageProfile = Message Profile 150C from messageDeposit
create new Message Delivery 170 incorporating message, targetingSpec, messageProfile
transmit Message Delivery 170 to individualSubject

}

}
else if (event is a Delivery Acknowledgement 171 from an individual Subject 120)
{

deliveryAcknowledgement = Delivery Acknowledgement 171
messageId = database key of originating Message Deposit 150 from deliveryAcknowledgement
reputationFeedback = Reputation Feedback 503 from deliveryAcknowledgement
responseCode = subject's message response category code from reputationFeedback

// e.g. timeout, deleted, consumed, spam (violation of informed prior consent)

violationCategory = category of informed-prior-consent violation from reputationFeedback
store responseCode and violationCategory in Message Store Database 136

// for Delivery Notification 180 (as agreed upon with sponsor, either
// following each delivery, or summarized at regular intervals, or
// aggregated into a final summary upon expiration of agreed-upon
// delivery time limit). Note individual subject permissions, denials and
// responses are kept anonymous in all cases.

retrieve sponsor's Reputation Index 501 from Sponsor Accounts Database 135

// note Reputation Index 501 contains not only a numerical score but
// the feedback sample size on which the score is based

recalculate Reputation Index 501 reflecting new feedback (responseCode, violationCategory)

// revise numerical index using published formula; update sample size

store updated Reputation Index 501 in Sponsor Accounts Database 135

// by means of Reputation Feedback Deposit 504

if (individual notification required by sponsor)

| | |
|---|---|
| transmit Delivery Notification 180 | // subject anonymity preserved |

}
else
{

// Transmission is some other kind of event unrelated to spam control
// - handle appropriately and continue

}

}

}

In the embodiment illustrated in FIG. 5, sender reputation is merely one of numerous descriptive elements comprising Message Profile 150C. As described in above (e.g., in paragraphs [0028], [0029], [0040] and [0041], etc.),

At least Message Profile 150C and Reputation Index 501 comprise a Message (Delivery) Permission Query 160, which is sent by the server via a communications network. When received by a Subject 120_{1 . . . n} client private messaging device, Message Profile 150C is matched against (e.g., compared to, assessed relative to, etc.) Subject's 120_{1 . . . n} Message Filtering Policies 110B (for example, by a Message Profile mechanism generally configured with instructions stored at and executable by a private messaging device under the control of a user—e.g., a computer, mobile phone, etc.—also referred to herein as a ‘client’), in the execution of Message Permission Query 160. Message Filtering Policies 110B may contain an indication of Subject 120_{1 . . . n}'s degree of tolerance for unsolicited messages, expressed in a minimum reputation threshold, perhaps combined with a minimum prior sample size for statistical confidence.

If Message Sponsor 110_{1 . . . m}'s Reputation Index 501 falls below the threshold specified by Subject 120_{1 . . . n}, then delivery permission is denied. Alternatively, according to an embodiment, a degree of tolerance for unsolicited messages could be expressed as a maximum reputation threshold (e.g., wherein a negative reputation is represented by a higher number than is a positive reputation, etc.), and the maximum threshold represents an upper limit at and/or beyond which delivery permission is denied. The Message Filtering Policies 110B are generally configured with instructions stored at and executable by a private messaging device under the control of a user (e.g., at Subject 120).

In general, Session Agent 122 acts as and/or incorporates the Message Profile mechanism and executes the activities described above within the privacy-protected confines of Subject 120's private messaging device (‘client-side’). Portions of an exemplary but non-exclusive embodiment of a Message Profile mechanism are represented by the following pseudocode:

while (Subject 120 is logged in)
{

if (Subject 120's event queue is empty)
{

| | |
|---|---|
| sleep | // wait for event notification |
| continue | // next ‘while’ loop iteration |

}
while (Subject 120's event queue contains events to process)
{

event = next event from head of queue
If (event is a Message Permission Query 160 from Anonymity Service 130)
{

permissionQuery = event
create Message Permission Query Result 161
filteringPoliciesAllowDelivery = true
targetAudienceIncludesSubject = true
if (Personal Profile 110A doesn't match Message Targeting 150B)

// details omitted; target matching unrelated to spam control

{

targetAudienceIncludesSubject = false
insert targetAudienceIncludesSubject in Message Permission Query Result 161
transmit Message Permission Query Result 161 in reply to Message Permission Query 160
continue // next ‘while’ loop iteration

}
filteringPolicies = Subject 120's Message Filtering Policies 110B // unencrypted at login time
foreach (filteringPolicy in filteringPolicies)
{

if (filteringPolicy is a sender reputation policy)
{

reputationPolicy = filerteringPolicy
mimimumReputationIndex = minimum reputation index from reputationPolicy
senderReputationIndex = Reputation Index 501 from from Message Permission Query
160

// Note: Reputation Index 501 contains not only a numerical score but the
// feedback sample size on which the score is based

if (reputationPolicy contains a minimum reputation sample size)
{

minimumSampleSize = minimum reputation sample size from
reputationPolicy
senderRepSampleSize = reputation sample size from Reputation Index 501
if (senderRepSampleSize < minimumSampleSize)

filteringPoliciesAllowDelivery = false

}
if (senderReputationIndex < mimimumReputationIndex)

filteringPoliciesAllowDelivery = false

}

}
deliveryIsMutuallyPermissible = true
if (filteringPoliciesAllowDelivery == false OR targetAudienceIncludesSubject == false)

deliveryIsMutuallyPermissible = false

insert deliveryIsMutuallyPermissible into Message Permission Query Result 161
transmit Message Permission Query Result 161 in reply to Message Permission Query 160

}
else if (event is a Message Delivery 170)
{

// Control cannot reach here unless prior delivery permission has been obtained by
// means of a previous Message Permission Query 160 with deliveryIsMutuallyPermissible == true
place message in display list for human subject's attention via User Interface 201
wait for interactive response
continue // next ‘while’ loop iteration

}
else if (event is interactive input from human subject via User Interface 201)
{

| responseCode = “none” | |
|---|---|
| violationCategory = “none” | |
| if (timeout) | // too much time elapsed without interactive response |

{

| responseCode = “timeout” | |
|---|---|
| create Delivery Acknowledgement 171 containing responseCode | |
| transmit Delivery Acknowledgement 171 in reply to Message Delivery 170 | |
| continue | // next ‘while’ loop iteration |

}
concatenate interactive input onto human subject's message response
if (interactive response is complete)
{

responseCode = category code from interactive response
if (interactive response is “delete”)

responseCode = “deleted”

else if (interactive response is “permission query was deceptive”)
{

// subject has identified message as “spam,” e.g.:
// - it purports to be, but is not, about a topic of interest to
// subject
// - it purports to be a type of message (e.g., political
// news) allowed by subject's filtering policies,
// but is actually some other category (e.g., donation
// request, petition request, third-party opt-in request)
// - it purports to be, but is not, authorized by account
// privilege, personal relationship, subscription or
// other prior opt-in agreement
// - etc.
responseCode = “informed prior consent violation”
violationCategory = category code from interactive response

}
else

responseCode = “consumed”

create Delivery Acknowledgement 171 containing responseCode
transmit Delivery Acknowledgement 171 in reply to Message Delivery 170

}

}
else
{

// Transmission is some other kind of database operation, such
// as an anonymous poll, survey, election ballot, request for
// anonymous demographic information, notification of a
// database schema change requiring migration of Subject's
// Personal Record 110 to a new format, etc., and is processed
// accordingly

}

}

}

The above exemplary pseudocode representation assumes that a login session has already been established as detailed above, and for purposes of clarity and concision, omits certain details about logging out and other such concerns. The pseudocode also, for descriptive simplicity, conflates Resident Application 121 and Session Agent 122 into a single entity (Subject 120 ) responsible for implementing the individual subject's message filtering policies and spam feedback contribution while protecting her privacy.

The exemplary pseudocode embodiment reflects to some degree the granularity of FIG. 5, which concerns an embodiment of a spam feedback loop without elaborating on internal organizational details better represented by FIGS. 2-4. Represented in this manner, the exemplary pseudocode simply omits layering details related to encrypting and decrypting communications.

The embodiments of a Message Profile Mechanism are not, however, intended to be restricted to the structure of the provided pseudocode representation, but include all variations and equivalents thereof that fall within the ordinary skill of an artisan informed by the provided exemplary embodiment.

If Subject 120_{1 . . . n}, upon consuming Message 150A, determines that the message was deceptively characterized, she may optionally flag the message as abusive, which objection (e.g., as message sponsor reputation-relevant feedback) becomes part of Delivery Acknowledgement 171 (see FIG. 4). The source of the feedback is recoverable by the system for purposes of legal accountability or arbitration, for example, but is anonymous from Message Sponsor's 110_{1 . . . m} point of view, such that retaliation is precluded. Lack of an objection implies that the message was honestly and accurately characterized.

Message Targeting and Filtering Database System (MTFDBS), before returning Delivery Notification 180 to Message Sponsor 110_{1 . . . m}, stores Reputation Feedback Deposit 503 in a private network-based Account Database (e.g., Sponsor Account Database 135) where it becomes part of Message Sponsor's 110_{1 . . . m} cumulative Reputation Index 501, which remains available for embedding in subsequent permission queries (Message Permission Query 160 ). By ‘private’, it is meant that the network-based Account Database is generally available only to subscribing users Subject 120_{1 . . . n}, and may in embodiments instead be considered ‘semi-private’.

Those of skill in the art will appreciate that Message Permission Query 160 is the permission query path by which the message profile reaches Subject's 120_{1 . . . n} private machine (e.g., subject user's private messaging device, or the like). If information included in the Message Permission Query 160 does not match Subject's 120_{1 . . . n} message filtering policies (including reputation threshold), then delivery permission is denied, for example by a Permission Query Response Mechanism, which may be generally configured with instructions stored at and executable by the private messaging device, and in an embodiment, may be included as a part of the Message Profile Mechanism.

In other words, a negative response to Message Permission Query 160 effectively blocks the message, while a positive response to a Message Permission Query 160 effectively is treated as informed consent to deliver the message. This is how Subject 120_{1 . . . n} is enabled by the invention in this embodiment to block a message from an ill-reputed sender. In such case, the user never sees the message. If the message instead matches Subject's 120_{1 . . . n} policies (including reputation threshold), or at least is not inconsistent with and/or contrary to Subject's 120_{1 . . . n} policies, then the message is delivered via path 170. It is then up to Subject(s) 120_{1 . . . n} to object if the characterization of the message as expressed in Message Profile 150C (see FIG. 1b) was deceptive. In that case, Delivery Acknowledgement 171, which includes Subject's 120_{1 . . . n} message sponsor reputation feedback, causes negative feedback to be added to the sender's history (e.g., Reputation Index), causing damage to Message Sponsor's 110_{1 . . . m} reputation rating.

The embodiment of the invention illustrated in FIG. 5, unlike other sender reputation systems extant and proposed, gives each Subject 120_{1 . . . n} private individual control over the use of sender reputation as a screening policy. This approach allows one or more of Subject 120_{1 . . . n} to disallow all bulk messages, for example, while allowing a different one or more of Subject 120_{1 . . . n} to accept them in exchange for compensation. At no time does any server-side component of Message Targeting and Filtering Database System (MTFDBS) have unencrypted access to Message Filtering Policies 110B, nor is it able to deduce which policy among those comprising Message Filtering Policies 110B caused a denial of delivery permission.

Thus, those of skill also will appreciate that an individual user's anonymity is preserved in accordance with the invention. In accordance with the invention, no one else—whether another Subject 120_{1 . . . n} or a Message Sponsor—will ever know the identity of the individual user who has reported on, e.g. given a negative rating of, a Message Sponsor's reputation. Thus, there is no possibility of increased targeted spamming or other retaliation against such an honest user rating.

Those of skill in the art will appreciate that individual users (Subject 120_{1 . . . n} private individuals) could establish more or less permissive filtering guidelines on top of the invented system, e.g. each could establish one or more Privileged Message Sponsors messages from which are delivered to the individual user regardless of the cumulative reputation of the Privileged Message Sponsor. Conversely, an individual user could establish a filtering rule that, despite the relatively good reputation rating of a particular Message Sponsor, all messages therefrom are deterred and avoided.

An important implication of the embodiment illustrated in FIG. 5 is that it suppresses spam by economic deterrence, not by content-based filtration, thereby eliminating the need for intrusive server-side message content filtering altogether, unlike other reputation filtering systems currently envisioned. In one variation, the invention might allow encryption of message content (subject to statutory law-enforcement requirements), in which case automated content filtering would be rendered not only unnecessary but impossible. With or without encryption, reputation filtering would be carried out in accordance with plural individual filtering policies (e.g., administered at the client level), not a single centralized policy (e.g., administered at the server level), and would be applied in the privacy of Subject 120_{1 . . . n}'s individual machine. The server side is relieved of spam filtering responsibilities, differentiating the inventive embodiments from prior art spam control systems.

Further, in a typical (but not exclusive) embodiment, the server initially delivers only a Message Delivery Permission Query to a Subject 120_{1 . . . n}, but does not deliver a message associated with the query until and unless the server receives permission from Subject 120_{1 . . . n}. This permission-gated, separated delivery approach differs from prior art methods. Additionally, as mentioned, the server, in a typical but non-exclusive embodiment, is entirely relieved of (e.g., is not permitted to perform) the task(s) of scanning and/or filtering message content or content associated with the message or message sponsor, to determine whether or not delivery of the message is permitted. Rather, the server, in delivering or not delivering the message, acts solely at the behest of the Subject 120_{1 . . . n}, after the Subject 120_{1 . . . n} applies its own Message Filtering Policies. While one or more of the interactive message filtering and delivery embodiments described herein may be slower than some prior art message delivery methods, user privacy and user control are greatly improved. Additionally, the cumulative user-feedback-definition of message sponsor reputation improves the robustness of the stored message sponsor reputation-relevant data for future filtration of messages from a sponsor.

Accordingly, a method and apparatus for a message targeting and filtering database system are described. From the foregoing description, those skilled in the art will recognize that many other variations of the invention are possible. Some of these variations have been discussed above but others may exist. Thus, the invention is not limited by the details described. Instead, the invention can be practiced with modifications and alterations within the spirit and scope of the appended claims.

It will be understood that the present invention is not limited to the method or detail of construction, fabrication, material, application or use described and illustrated herein. Indeed, any suitable variation of fabrication, use, or application is contemplated as an alternative embodiment, and thus is within the spirit and scope, of the invention.

It is further intended that any other embodiments of the present invention that result from any changes in application or method of use or operation, configuration, method of manufacture, shape, size, or material, which are not specified within the detailed written description or illustrations contained herein yet would be understood by one skilled in the art, are within the scope of the present invention.

Finally, those of skill in the art will appreciate that the invented method, system and apparatus described and illustrated herein may be implemented in software (e.g., device-executable instructions generally stored at a data storage mechanism of a device and/or readable by a device from a portable data storage media operatively coupled therewith), firmware or hardware, or any suitable combination thereof. Preferably, the method system and apparatus are implemented in a combination of the three, for purposes of low cost and flexibility. Thus, those of skill in the art will appreciate that embodiments of the methods and system of the invention may be implemented by a computer or microprocessor process in which instructions are executed, the instructions being stored for execution on a computer-readable medium and being executed by any suitable instruction processor.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

I claim:

1. A spam deterrence apparatus for use in a secure messaging system, the apparatus comprising:
an individualized message filtering policy mechanism including message filtering policy instructions stored on a data-storage medium, wherein the message filtering policy instructions are configured to be executed on a user's private messaging device, and wherein the message filtering policy mechanism further includes message sponsor reputation-relevant criteria established by the subject user;
a message profile mechanism coupled with the message filtering policy mechanism and configured with likewise stored and likewise executable instructions configured, when executed by the messaging device, to compare the message filtering policy mechanism with a message profile of a message received at the messaging device and to assess a level of compliance of the message profile with the message filtering policy,
the message filtering policy mechanism and the message profile mechanism being operatively coupled with one another within the messaging device.

2. The apparatus of claim 1, wherein the individualized message filtering policy mechanism is stored in encrypted form, and wherein the individualized message filtering policy mechanism remains accessible only by the messaging device when de-encrypted for execution by the messaging device.

3. The apparatus of claim 1, further comprising:
a reputation feedback mechanism operatively coupled with the message profile mechanism and further communicatively coupled with a network-based server, the feedback mechanism configured with likewise stored and likewise executable instructions enabling the user to post to the server a reputation rating that includes information relating to the subject user's assessment of the honesty and accuracy of sponsor-provided, message content-characterizing information in the message profile of the received message.

4. The apparatus of claim 1 further comprising:
a permission query response mechanism configured with likewise stored and likewise executable instructions, and further configured to one of establish or withhold an individual user's informed consent to accept a sponsor's message.

5. The apparatus of claim 1, wherein the spam deterrence apparatus is operatively coupled with a network-based server and includes likewise stored and likewise executable instructions configured to enable the messaging device to transmit to the server a delivery acknowledgement indicating the assessed level of compliance of the message profile with the message filtering policy.

6. A decentralized messaging device-executed spam deterrence method, the method comprising:
storing client user-defined message filtering policies at a device-readable medium of a client, wherein the filtering policies comprise device-executable instructions;
receiving a message delivery permission query at the client, the query including a message profile configured in part with reputation information relating to a sponsor of the message;
comparing the message profile of the query with the client user-defined message filtering policies;
determining a permission status of the message profile relative to the message filtering policies; and
executing a delivery action for the message based at least in part upon the permission status.

7. The method of claim 6, wherein the reputation information includes a reputation index corresponding to a sponsor of the message.

8. The method of claim 6, wherein the message filtering policies include a message sponsor reputation index acceptance threshold.

9. The method of claim 8, wherein executing the delivery action includes transmitting a query response from the client to a network-based sponsor accounts database, the query response denying message delivery permission if the sponsor reputation index does not meet the message sponsor reputation index acceptance threshold.

10. The method of claim 6, wherein executing the delivery action includes transmitting a query response from the client to a network-based sponsor accounts database, the query response granting message delivery permission unless the message profile includes one or more characteristics conflicting with the client user-defined message filtering policies.

11. The method of claim 6, further comprising:
transmitting a client user-determined message sponsor-reputation feedback deposit from the client to a network-based sponsor accounts database; and
storing the reputation feedback deposit at the network-based sponsor accounts database.

12. The method of claim 11, wherein the stored client user-determined reputation feedback deposit alters a designated message sponsor's cumulative reputation index, and wherein the source of the client user-determined reputation feedback deposit is maintained in anonymity by the sponsor accounts database relative to the message sponsor.

13. A secure, client-directed message targeting and filtering system, comprising:
a server coupled with a communications network, the server being configured with a sponsor accounts database, the database including cumulative message sponsor reputation-relevant information, the server further being configured to include the message sponsor reputation-relevant information with a message profile and to transmit the message profile and the message sponsor reputation-relevant information via the network as part of a message delivery permission query; and
device-executable instructions stored at a device-readable storage medium, wherein the instructions are configured to be executed on and by a client messaging device, and wherein the instructions comprise message filtering policies relating to the sponsor reputation-relevant information.

14. The system of claim 13, wherein the message filtering policies remain encrypted except when de-encrypted for use by the client messaging device, and wherein the de-encrypted message filtering policies remain inaccessible to the server.

15. The system of claim 13, further comprising:
message profile assessment instructions stored at a data storage medium and configured to be executed on and by the private messaging device, wherein the assessment instructions are further configured to compare the sponsor reputation-relevant information to the message filtering policies, and wherein the comparing takes place independently from the content of the message.

16. The system of claim 13, wherein the message filtering policies are configurable by a user of the client messaging device to establish message sponsor reputation-based criteria for handling a message delivery permission query received from the server.

17. The system of claim 15, wherein the message profile assessment instructions are further configured to compare message sponsor reputation-relevant information in the message delivery permission query with a client messaging device user-specified reputation threshold of the message filtering policies.

18. The system of claim 16, wherein the handling includes sending to the server a response indicating permission to deliver a message unless the sponsor reputation-relevant information includes one or more characteristics conflicting with the message filtering policies.

19. The system of claim 15, further comprising:
message delivery acknowledgement instructions likewise stored at a data storage medium and configured for execution on and by the client messaging device, the acknowledgement instructions further configured to transmit a delivery acknowledgement message from the client messaging device to the server, the delivery acknowledgement message including information indicating receipt of a message at the client messaging device.

20. The system of claim 19, wherein the delivery acknowledgement message also includes message sponsor reputation-relevant feedback determined by the user of the client messaging device, the message sponsor reputation-relevant feedback relating to a client messaging device user-determined level of correlation between message sponsor-provided information in the message delivery permission query and client-reviewed content of the message, wherein the server is configured to alter the cumulative message sponsor reputation-relevant information stored at the sponsor accounts database relative to the transmitted message sponsor-reputation relevant feedback, and wherein the server is further configured to prevent discovery by the message sponsor of the source of the message sponsor reputation-relevant feedback.
